(19) United States
(12) Patent Application Publication
(10) Pub. No.: US 2025/0235976 A1
(43) Pub. Date: Jul. 24, 2025

(54) METHOD FOR DETERMINING A POSITION OF AN OPTICAL WAVEGUIDING CORE BODY OF AN OPTICAL WAVEGUIDE, METHOD FOR MACHINING AN OPTICAL WAVEGUIDE, MACHINE TOOL FOR MACHINING AN OPTICAL WAVEGUIDE, AND CONTROL DEVICE

(71) Applicant: DMG Mori Ultrasonic Lasertec GmbH, Stipshausen (DE)

(72) Inventors: Fabian FRANZMANN, Veitsrodt (DE); Heiko MARX, Morbach (DE); Jonas FEY, Meckenbach (DE); Phillip GÖBEL, Kirschweiler (DE); Viktor DOLINGER, Bernkastel-Kues (DE)

(73) Assignee: DMG Mori Ultrasonic Lasertec GmbH, Stipshausen (DE)

(21) Appl. No.: 18/705,466

(22) PCT Filed: Aug. 10, 2022
(86) PCT No.: PCT/EP2022/072391

§ 371 Date: Apr. 26, 2024

(30) Foreign Application Priority Data
Oct. 29, 2021 (DE) 10 2021 128 352.3

(51) Int. Cl. B24B 13/00; G01B 5/008; G01M 11/00

(52) U.S. Cl. CPC B24B 13/00; G01B 5/008; G01M 11/31

(57) ABSTRACT

A method determines a position of a light wave guiding core body of an optical waveguide for machining on a numerically controlled machine tool. The waveguide includes the core body and a shell body enclosing it, both extending from a first end face to a second end face of the waveguide. The method includes providing an optical measurement system, including a light source device and a detection device, and measuring the first end face by the optical measurement system, including irradiating the waveguide by the light source, detecting radiation emitted by the first end face, and determining a position of a center point of the core body on the first end face based on the detected radiation. The optical measurement system is arranged on the machine tool. The measurement of the first end face is performed on the waveguide clamped on the machine table by the optical measurement system.

### CROSS-REFERENCE TO RELATED APPLICATIONS

This application is a US National Phase of International Patent Application Number PCT/EP2022/072391, filed on Aug. 10, 2022, claiming priority to German Patent Application Number DE 10 2021 128 352.3, filed on Oct. 29, 2021, the contents of each of which are hereby incorporated into the subject matter of the present application by reference.

### TECHNICAL FIELD

The present disclosure relates to a method for determining a position of a light wave guiding core body of an optical waveguide for machining on a numerically controlled machine tool, a method for machining an optical waveguide on a numerically controlled machine tool, a machine tool for machining an optical waveguide, and a control device for use on a machine tool.

### BACKGROUND

The use of optical waveguides is known from the prior art, which are used in numerous areas for the purposes of energy transmission, communication technology with data and signal transmission, lighting and many more applications. Such optical waveguides, which are often also referred to as optical waveguide cables, fiber optic cables or the like, are designed to transmit electromagnetic radiation, especially light, and for this purpose comprise at least one light wave guiding core body (also called optical fiber) and a shell body surrounding it, whereby the electromagnetic radiation or light to be transmitted is guided along a longitudinal direction of the core body.

In the field of communication technology, optical waveguides offer significantly higher transmission rates and ranges compared to electrical conductors, enabling almost loss-free communication without any significant time delay between transmitter and receiver.

In the course of manufacturing such optical waveguides, an initial optical waveguide or an optical waveguide blank is heated and then drawn along the longitudinal direction of the core body or the optical waveguide in a subsequent deforming drawing process. Depending on the implementation of the drawing process, changes in length of around 1/40000 can be achieved in relation to the longitudinal direction, so that, for example, a 40-kilometer-long optical waveguide can be drawn from an optical waveguide blank having a length of one meter.

In the run-up to such drawing processes, preparatory machining of the optical waveguide or the optical waveguide blank usually takes place on a machine tool. For example, during such preparation for a drawing process known from the prior art, holes are inserted into the shell body which run as parallel as possible to the core body enclosed by the shell body. Said holes are flushed with a hot fluid for the thermal drawing process in order to make the optical waveguide deformable and to be able to draw it in length.

The preparatory machining must be carried out with high precision and in compliance with relatively small tolerances and is made even more difficult by production-related deviations in the original shape of the optical waveguide or the optical waveguide blank to be machined, as a result of which the core body is usually not exactly centered in the shell body.

To compensate for said deviations, methods are known from the prior art in which an optical waveguide to be machined or an optical waveguide blank is measured with the aid of an optical microscope in order to determine the position of the core body in the optical waveguide. The measured optical waveguide or the optical waveguide blank to be machined is then clamped in a machine tool, where it is machined taking the measurement results into account.

### SUMMARY

One task of the present disclosure is to provide an improved and, above all, more precise way of machining an optical waveguide on a machine tool compared to the prior art.

To solve this task, a method for determining a position of a light wave guiding core body of an optical waveguide, a method for machining an optical waveguide, and a machine tool for machining an optical waveguide according to independent claims, and a control device according to a dependent claim are provided.

The respective dependent claims refer to preferred examples, which can be provided individually or in combination.

According to a first aspect, a method for determining a position of a light wave guiding core body of an optical waveguide for machining on a numerically controlled machine tool is provided, wherein the optical waveguide comprises at least the core body and a shell body enclosing the core body, both extending from a first end face of the optical waveguide to a second end face of the optical waveguide. The method comprises providing an optical measuring system comprising at least a light source device and a detection device, and measuring the first end face of the optical waveguide by means of the optical measuring system, which comprises irradiating the optical waveguide by means of the light source device, detecting a radiation emitted by the first end face due to the irradiating of the optical waveguide by means of the detection device, and determining a position, relative to the shell body, of a center point of the core body on the first end face on the basis of the detected radiation. The method is performed on a numerically controlled machine tool, and further comprises clamping the optical waveguide to a machine table of the numerically controlled machine tool. The optical measurement system is arranged on the numerically controlled machine tool and the measurement of the first end face is performed on the optical waveguide mounted on the machine table by means of the optical measurement system arranged on the numerically controlled machine tool.

The method breaks with the separate procedure known from the prior art and enables the optical waveguide to be measured for the purpose of determining the position of the light wave guiding core body while it is clamped on the machine tool for subsequent machining. An optical waveguide is also to be understood as an optical waveguide blank, since each optical waveguide blank itself is also an optical waveguide.

Compared to the prior art, deviations between an actual geometry of the optical waveguide in the clamped state, in particular a position of the core body with respect to the shell body, and the measurement results can be significantly reduced or compensated for by means of the method provided.

In the procedure known from the prior art, such deviations can result, among other things, from inserting the optical waveguide measured outside the machine tool into a workspace of the machine tool and clamping it there. This can be caused, for example, by different conditions in a measurement environment outside the machine tool and in the workspace, so that a temperature difference can lead, for example, to thermally induced deformation of the optical waveguide and thus to deviations from the measurement results and correspondingly less accurate subsequent machining. Mechanical deformations (including elastic deformations) can also occur, which are caused by the application of clamping forces in the machine tool.

By measuring the optical waveguide already clamped for subsequent machining in the machine tool in accordance with the disclosure, a measuring environment not only corresponds to a machining environment at the same time, but the measuring and the machining based on the measurement results obtained from it take place under essentially the same boundary conditions for the optical waveguide. As a result, there are none of the aforementioned deviations that occur in the prior art, so that particularly precise machining can be carried out on the basis of the largely unadulterated measurement results.

In this sense, the accuracy of the subsequent machining by the machine tool is already increased by knowing the position of the center of the core body on the first end face of the clamped optical waveguide with respect to the shell body. For example, it can be ensured that when machining the shell body at the first end face, a tool is applied to the shell body and not to the core body. Furthermore, the said attachment point for the tool can be positioned particularly precisely in relation to the core body, for example to maintain a predetermined distance.

It may be necessary to align the optical measuring system relative to the clamped optical waveguide or its first end face before measuring the first end face, e.g. by moving the machine table or the measuring system itself, to be able to detect radiation at all or to enable irradiating.

The irradiating of the optical waveguide performed in the course of measuring the first end face is preferably performed with electromagnetic radiation from the optical frequency range provided by the light source device, which comprises ultraviolet radiation, visible light and infrared radiation, but should not be limited to this as long as the detection device is suitable for detecting at least part of the frequency range of the electromagnetic radiation provided by the light source device. Preferably, the detection device is a camera, and particularly preferably a microscope camera, which derives image data from the detected radiation for the subsequent center point determination step. Compared to a normal camera, a microscope camera can achieve a higher image resolution and therefore a higher measurement accuracy.

The radiation emitted by the first end face is to be understood as any electromagnetic radiation caused by the irradiating of the optical waveguide, which, for example, enters the detection device through emission, transmission or reflection processes from the first end face.

Due to the typically different optical conductivity properties of the shell body and the core body, a difference, e.g. a difference in intensity or a difference in frequency, in the radiation emitted by the core body and in the radiation emitted by the shell body (compared to detection in pure ambient light) can be amplified by the targeted irradiating of the optical waveguide when detecting the radiation emitted by the first end face by means of the detection device. The resulting image data thus shows a higher contrast between the said bodies, which in turn improves the accuracy in determining the position of the center of the core body. The simplified statement that a contrast in the detected radiation is increased is intended to describe the previously described circumstance of a greater difference between the radiation components of the cladding and core body, on the basis of which image data with increased contrast between said bodies on the end face can be derived.

It is preferred that the majority of the irradiation of the core body takes place when irradiating the optical waveguide, such that a proportion of the irradiation penetrating into the core body is greater than a proportion of the irradiation of the light source device penetrating into the shell body. Due to the very good conductivity properties of the core body, which are required for use as an optical waveguide, this further increases the contrast in the detected radiation.

The term position is generally understood to mean a combination of information suitable for spatial description, with which a position and optionally also an orientation of an object to be described can be clearly specified relative to a selected reference system. The reference system defines the reference for specifying the position and, in the field of machine kinematics, usually corresponds to a physical body, in particular a machine part. For example, a machine frame of the machine tool, the machine table of the machine tool or the optical waveguide itself can be defined as a reference system. For mathematical description, a reference system is usually assigned a coordinate system that is fixed to the body or reference system. The position of an object or body should only be understood as the location of an object-fixed point in relation to the selected reference system. This can, for example, be specified by a position vector of the object-fixed point in a (reference system-fixed) coordinate system of the reference system. Orientation, on the other hand, refers to an orientation or inclination of the object in relation to the selected reference system. This can be specified, for example, by the angle of rotation of an object-fixed coordinate system in relation to the coordinate system of the reference system.

The respective reference system in relation to which a relative position is specified is usually specified below using the preposition “with respect to”. Any number of coordinate systems can be assigned to each individual reference system. It should be noted that the choice of origin and base vectors of a coordinate system belonging to a reference system is in no way prescribed, but can be chosen at will. Furthermore, coordinate systems of different, but also identical reference systems, can also be converted into each other, e.g. by shifting and/or rotating them.

The determined relative position of the center of the core body with respect to the shell body is preferably indicated in a coordinate system fixed to the optical waveguide and thus also in a coordinate system fixed to the shell body, which preferably has its origin on the first or the second end face, preferably with two of its base vectors lying in a plane of the first or the second end face. In this way, the position of the center of the core body on the first end face with respect to the shell body (as reference system) can be specified particularly simply by specifying a position vector in said coordinate system.

The position of a point per se, such as the center point on the first end face in this case, does not require any information relating to the orientation, whereas, for example, a center line of the core body can be described by a location vector describing the position, e.g. to the center point on the first end face, and a direction vector describing the orientation of the center line.

Determining the position of said center point is essential for subsequent machining, as it corresponds to a piercing point of the center line of the core body on the first end face and, due to the manufacturing or forming process, usually does not correspond to the geometric center point of the first end face and differs also from optical waveguide to optical waveguide.

Preferably, the method can be supplemented by a step taking place before measuring outside the machine tool and determining the position of the light wave guiding core body based thereon. The position determined in this prior art step can be supplemented by the position determined on the clamped optical waveguide, in this case at least the center point of the core body on the first end face. For this purpose, the method preferably comprises determining one or more compensation parameters which can be used by a control device of the machine tool and which relate to a deviation in the position of the light wave guiding core body caused by clamping, on the basis of the measurement results from the upstream step and at least the position of the center point of the core body on the first end face determined with respect to the shell body when the optical waveguide is clamped.

The aforementioned step is not limited to the position on the first end face determined with respect to the shell body, but can optionally also be carried out on the basis of the positions determined in the following preferred examples of the method (center point on the second end face, center line of the core body, etc.). The compensation parameters determined in this way serve to compensate for said deviations and thus increase the accuracy in the subsequent machining of the optical waveguide.

In an example, irradiating the clamped optical waveguide to measure the first end face of the clamped optical waveguide comprises irradiating at least a subsection of the second end face of the clamped optical waveguide by means of the light source device.

The irradiating radiation emanating from the first end face essentially has a portion of the irradiating radiation transmitted from the second end face through the optical waveguide, in particular through the core body, by the light source device.

Preferably, an end face of the core body on the second end face lies completely in the irradiated subsection and, particularly preferably, an area proportion of the end face of the core body on the subsection on the second end face is greater than an area proportion of an end face of the shell body on the second end face in relation to the subsection. As a result, the majority of the irradiating radiation is transmitted through the core body, which additionally increases the contrast in the detected radiation and improves the position determination.

In an example, irradiating the clamped optical waveguide to measure the first end face of the clamped optical waveguide comprises irradiating at least a subsection of the first end face of the clamped optical waveguide by means of the light source device.

In this case, the radiation emitted by the first end face is essentially composed of a portion reflected by the first end face and a portion reflected at the second end face of a portion of the irradiating radiation transmitted by the light source device through the optical waveguide, in particular through the core body.

Due to the fact that irradiating and detection take place with respect to the same end face, here the first end face, a particularly compact optical measurement system can be provided in an advantageous manner compared to the example described above, whereby the light source device and the detection device are arranged locally close to each other and preferably within a common housing, which considerably simplifies, for example, handling of the optical measurement system on the machine tool (e.g. in the form of a pick-up from a tool rest or a movement of the measurement system).

Thus, said devices for measuring can be positioned together opposite the optical waveguide or the first end face in one step, whereas a locally separate design requires a more time-consuming positioning of the detection device and the light source device.

In order to further increase the difference in the detected radiation of the shell body and the core body and thus the contrast, it is particularly useful to arrange a reflective device on the second end face, e.g. in the form of a mirror, in order to guide a larger proportion of the radiation transmitted by the optical waveguide from the first end face back to the first end face.

In an example, the optical measurement system further comprises a reflection device for reflecting the irradiating radiation provided by the light source device, wherein the measurement of the first end face of the clamped optical waveguide further comprises an arrangement of the reflection device opposite the second end face of the clamped optical waveguide and facing it, such that the reflection device reflects at least a portion of the radiation guided through the optical waveguide starting from the irradiated first end face and subsequently emanating from the second end face back onto the second end face.

Preferably, an end face of the core body on the first end face lies completely in the irradiated subsection and, particularly preferably, an area proportion of the end face of the core body on the subsection on the first end face is greater than an area proportion of an end face of the shell body on the first end face in relation to the subsection. This additionally increases the contrast in the detected radiation and improves position detection.

In an example, the detection device and the light source device of the optical measuring system are designed as a uniform measuring device in such a way that they always have a constant relative positioning to each other. This simplifies the placement of the optical measuring system relative to the clamped optical waveguide, since only the measuring device and not two separately designed devices have to be positioned and aligned.

In an example, at least a part of the optical measuring system, in particular the detection device, and the machine table are movable relative to each other by at least one numerically controllable axis of the machine tool.

In this way, a possibility for the relative alignment of the clamped optical waveguide and the optical measuring system is implemented via a controllable axis of the machine tool, especially in the run-up to measuring the first end face, whereby conceptually different measuring arrangements with various advantages can be implemented on the machine tool. For example, geometrically different optical waveguides can be measured without having to manually adjust the alignment to anew geometry in each case; this can be done by the numerically controlled machine tool itself. In another example, the machine table with the optical waveguide mounted can be moved into an area in the work space that is separate from a machining area and intended for measurement, in which the optical measurement system is firmly arranged on a machine frame of the machine tool, whereby the measurement system is as far away as possible from the machining area and is thus protected as far as possible from any contamination that may occur. In another example, the measurement system can be moved into and out of the workspace of the machine tool via the at least one numerically controllable axis, whereby the measurement system can be completely protected from contamination during machining in the work space.

Traversing movements by numerically controllable axes are understood here and below to mean both translatory movements via linear axes along translatory axes/translational axes and rotary movements via rotary axes around rotatory axes/rotational axes of the machine tool.

In an example, the machine tool comprises a machining device with a working spindle configured to hold a tool, at least the detection device of the optical measuring system being arranged on the machining device. Furthermore, the machine tool is configured to move the machine table and the machining device relative to one another via a plurality of numerically controllable axes, in particular via three linear axes and two rotary axes. The uniform measuring device with light source device and detection device is preferably arranged on the machining device.

This provides a particularly flexible way of positioning the optical measuring system relative to the optical waveguide mounted on the machine table. At the same time, the machine tool, which is designed in particular as a 5-axis machine, with the large number of numerically controllable axes, offers the possibility of carrying out a wide variety of machining operations in a wide variety of directions on the clamped optical waveguide after the position has been determined. In particular, a 5-axis machine design, in which the machining device is movable over three linear axes and the machine table over two rotary axes relative to a machine frame, allows machining to obtain almost any final geometry, so that not only can the optical waveguide clamped there be measured on a single machine tool, but all the necessary machining steps can also be carried out afterwards, which not only saves time, but also avoids machining errors or inaccuracies otherwise caused by reclamping between several machine tools and/or external measuring devices.

Furthermore, the detection device for measuring and a tool for subsequent machining are arranged on the same machine part, so that the results of the position determination utilized during machining with the tool are not falsified by position tolerances between different machine parts, enabling particularly precise position determination with regard to machining.

In this example, the detection device and light source device are preferably designed as a uniform measurement device in order to provide a compact and thus possibly easy to move optical measurement system.

In an example, at least the detection device of the optical measuring system, preferably the uniform measuring device, is accommodated by the working spindle of the machining device.

This advantageously enables the optical measurement system to be inserted and removed by the working spindle, which acts as a universal interface for the measurement system and for tools for subsequent machining. For example, the detection device or the entire measuring device can be removed from a tool magazine or tool holder before the process is carried out and then returned to it. Furthermore, the tool and detection device are arranged at essentially the same position in relation to the machining device, which further increases the accuracy of the position determination with regard to the subsequent machining.

In an example, the method further comprises determining a position of the first end face of the clamped optical waveguide with respect to the machine tool in a first coordinate system of the machine tool, in particular with respect to a machine frame of the machine tool in a machine-table-fixed coordinate system or with respect to the machine table in a machine-table-fixed coordinate system, and a determination of a position of the center of the core body on the first end face of the clamped optical waveguide with respect to the machine tool in the first coordinate system of the machine tool, in particular with respect to the machine frame of the machine tool in the machine-table-fixed coordinate system or with respect to the machine table in the machine-table-fixed coordinate system, on the basis of the determined position of the first end face of the clamped optical waveguide and the determined relative position of the center of the core body on the first end face with respect to the shell body.

This provides in a particularly simple way a description of the position of the optical waveguide or the first end face of the optical waveguide suitable for utilization by a control device of the machine tool, which, together with the previously determined position of the center point on the first end face with respect to the shell body, leads to a description of the position of said center point that can also be utilized by the control device.

Reference systems of the machine tool are understood to be all possible reference systems of the machine tool, whereby each individual machine part can be understood as a reference system. The choice of a reference system for describing the determined positions is arbitrary, as is the choice of the coordinate system of the selected reference system, whereby the coordinate system selected for the description is to be referred to as the first coordinate system. As is known from the prior art, the kinematics of a machine tool can be described using several coordinate systems, each assigned to different reference systems (i.e. the machine parts), which can be converted into one another on the basis of position parameters for the numerically controllable axes. Depending on the reference system of the machine tool in which the control device performs the control of the machine tool, the determined positions relating to the optical waveguide are converted into a coordinate system of the reference system used for control for the purpose of utilization by the control device. When describing the machine table as a reference system with a machine-table-fixed coordinate system, the advantage is that the positions of the optical waveguide determined with respect to the machine table are constant positions (the optical waveguide is fixed to the machine table), which can be converted relatively easily into any other reference system of the machine tool.

In a preferred example, the position of the first end face of the clamped optical waveguide with respect to the machine tool is determined using a tactile measurement system arranged on the machine tool with a touch probe device.

Preferably, determining the position of the first end face of the clamped optical waveguide with respect to the machine tool by means of the tactile measuring system comprises detecting one or more positions of surface points of the clamped optical waveguide with respect to the machine tool by means of the touch probe device of the tactile measuring system and determining the position of the first end face of the clamped optical waveguide with respect to the machine tool on the basis of the one or more detected positions.

Preferably, the determination of the position of the first end face of the clamped optical waveguide with respect to the machine tool by means of the tactile measuring system further comprises a provision of at least one geometry parameter relating to the geometry of the clamped optical waveguide, in particular in the form of CAD data, wherein the determination of the position of the first end face of the clamped optical waveguide with respect to the machine tool is additionally carried out on the basis of the at least one geometry parameter provided.

By using a tactile measuring system with a touch probe device, the position of the optical waveguide in relation to the machine tool can be determined as simply as possible and in a way that is established in the state of the art.

In an example, the method further comprises determining a position of a centerline of the core body with respect to the machine tool based on the position of the center of the core body on the first end face of the clamped optical waveguide determined with respect to the machine tool and the position of the first end face of the clamped optical waveguide determined with respect to the machine tool. The position can be specified in the first or in any other coordinate system of the machine tool, if necessary, with prior conversion.

In this way, a first approach for determining a position of the centerline of the core body is provided, which uses the simplifying assumption of a centerline orthogonal to the first end face. If the position of the first end face and the center of the core body there are known, the position of the center line with respect to the machine tool, e.g. in the first coordinate system, can be specified in a short time in view of the simplifying assumption.

In an example, the method further comprises measuring the second end face of the clamped optical waveguide by means of the optical measuring system arranged on the numerically controlled machine tool, determining a position of the second end face of the mounted optical waveguide with respect to the machine tool, and determining a position of the center point of the core body on the second end face of the mounted optical waveguide with respect to the machine tool, wherein the aforementioned steps can be carried out analogously to any advantageous or preferred example already described in the context of determining the position of the center point on the first end face.

In this way, the position of the center of the core body on the second end face can also be provided in a form that can be used by the control device.

In an example, the method additionally comprises determining a position of a centerline of the core body with respect to the machine tool on the basis of the positions of the centers of the core body on the first and second end faces of the clamped optical waveguide determined with respect to the machine tool. The position can be specified in the first or in any other coordinate system of the machine tool, if necessary, with prior conversion

In this way, based on the descriptions of the positions of the centers of the core body on the first and second end faces that can be used by the control device, a particularly precise description of the position of the center line of the core body with respect to the machine tool is made possible in an advantageous manner, which, in contrast to the simplifying assumption of a core body running orthogonally to the end face, can also detect production-related, angular misalignments of the core body within the shell body (see also FIG. 1b) with high precision and which can be taken into account accordingly during subsequent machining.

According to a second aspect of the disclosure, there is provided a method for machining an optical waveguide on a numerically controlled machine tool, wherein the optical waveguide has the structure already described in the course of the description of the first aspect of the disclosure. The method comprises providing a numerically controlled machine tool with a machine table and a machining device with a working spindle configured to receive a tool, wherein the machine tool is configured to move the machine table and the machining device relative to one another via a plurality of numerically controllable axes, in particular via three linear axes and two rotary axes, clamping the optical waveguide onto the machine table of the machine tool, determining a position of the light wave guiding core body of the optical waveguide clamped on the machine table according to a method according to the first aspect of the disclosure, providing the determined position to a control device set up for controlling the machine tool, and machining the clamped optical waveguide by means of a tool received by the working spindle at least as a function of the determined position provided to the control device.

The method according to the second aspect relates to machining of the light wave body measured by the advantageous method according to the first aspect and, based on the precise determination of the position of the light wave guiding core body described above, permits particularly precise machining of the clamped optical waveguide.

The numerical machine tool provided is preferably a 5-axis machine in which the machine table is movable via two rotary axes relative to a machine frame and the machining device is movable via three linear axes relative to the machine frame. This enables a particularly flexible and almost unlimited positioning of the clamped optical waveguide and the working spindle, which results in almost unlimited machining possibilities.

In an example, the detection device and optionally the light source device of the optical measuring system, which can in particular be designed as a uniform measuring device, are received by the working spindle of the machine tool in order to determine the position of the light wave guiding core body, and the tool is received by the working spindle of the machine tool in order to machine the clamped optical waveguide.

As a result, the working spindle advantageously works as an interface for both the optical measurement system and the tool, which minimizes errors in position determination with regard to subsequent machining.

In an example, the machining of the clamped optical waveguide is a material-removing process. Removing the material can preferably be carried out by a cutting tool or by a laser-based tool using laser radiation.

In preparation for a thermal drawing process, material is removed, for example, to create clamping sections on the shell body or holes/channels for fluid-based heating. By knowing the position of the core body, it is advantageous to avoid damaging it during machining. Instead, the material can be removed in a predetermined relationship to the core body while maintaining particularly low tolerances.

In an example, the tool held by the working spindle for machining the optical waveguide comprises a vibration generator which is configured to excite a part of the tool intended for material removing to vibrate during machining of the clamped optical waveguide, in particular with a vibration frequency in the ultrasonic range.

This not only significantly reduces the process forces required for machining, but also enables the shell body, which is usually made of a hard-brittle material, to be machined with a comparatively high surface quality, e.g. with low roughness and in compliance with low manufacturing tolerances.

Such a high surface quality is particularly advantageous with regard to inserting channels for the subsequent passage of a heating fluid in the course of the thermal drawing process, as a largely laminar flow without turbulence can be realized in a boundary area to the channel walls.

In an example, in order to provide a position of a centerline of the core body of the clamped optical waveguide to the control device, the position of the light wave guiding core body of the clamped optical waveguide is determined according to an example of the method according to the first aspect, in which a position of said centerline of the clamped optical waveguide with respect to the machine tool is determined. The machining of the clamped optical waveguide comprises inserting at least one channel, preferably inserting at least two channels, into the shell body of the clamped optical waveguide, wherein the channel or channels to be inserted extend from the first end face substantially parallel to the center line of the core body at least partially through the shell body, in particular continuously up to the second end face.

By inserting the channel or channels in parallel, the optical waveguide is optimally prepared for a thermal drawing process, as in this way the heat transfer between the fluid flowing in the channel and the core body running parallel to it remains constant and does not fluctuate due to a variable distance. In this way, a particularly uniform thermal drawing process can be achieved with uniform deformation of the core body. Insertion can be carried out continuously from one end face or only partially from the first end face and then from the second end face, with the two partial channels joining together.

Essentially parallel means that, despite precise determination of the position of the center line, deviations cannot be completely avoided during production. Essentially parallel is therefore to be understood as parallel within the accuracy that can be maintained by the machine tool.

In an example, inserting the at least one channel into the shell body comprises aligning the machine table and the machining device by controlling one or more axes of the plurality of numerically controllable axes depending on the position of the centerline of the core body provided to the control device, such that the centerline of the core body is substantially parallel to an extension of a spindle axis of the tool-carrying working spindle, and relative movement of the tool-carrying working spindle and the machine table in a feed direction along the spindle axis.

In this way, the centerline of the core body is aligned exactly parallel to the feed direction of the spindle axis, so that only the numerically controllable axis configured for the feed movement along the spindle axis needs to be controlled when inserting the channel. The actual machining movement is therefore kept particularly simple in terms of control technology.

According to a third aspect of the disclosure, there is provided a machine tool for machining an optical waveguide having at least a light wave guiding core body and a shell body enclosing the core body and extending from a first end face of the optical waveguide to a second end face of the optical waveguide. The machine tool is designed as a numerically controlled machine tool and comprises at least one machine table, a machining device with a working spindle arranged to receive a tool, a control device arranged to control the machine tool and a plurality of axes which can be numerically controlled via the control device for the relative movement of the machine table and the machining device. An optical measurement system can be arranged on the machine tool, which comprises a light source device and a detection device and can be coupled to the control device. With the optical measurement system arranged on the machine tool, the control device is configured to measure a first end face of an optical waveguide mounted on the machine table by means of the optical measurement system, wherein the control device is at least configured to control the light source device in such a way that the light source device detects the mounted optical waveguide, that it irradiates the clamped optical waveguide, the detection device is configured to detect an emission emanating from the first end face of the irradiated clamped optical waveguide and to transmit this descriptive detection data to an evaluation unit of the control device. The evaluation unit is configured to determine, on the basis of the transmitted detection data, a position relative to the shell body of a center point of the core body on the first end face of the clamped optical wave guiding.

Thus, the machine tool is adapted for carrying out methods according to the first and second aspects of the disclosure, with all the advantages already explained in this respect and the examples.

Preferably, the optical measuring system is designed as part of the machine tool.

In an example, the evaluation unit of the control device is configured to determine a position of the first end face of the clamped optical waveguide with respect to the machine tool, in particular with respect to the machine table, in particular by means of a tactile measuring system, and is further configured to determine a position of the center of the core body on the first end face of the clamped optical waveguide with respect to the machine tool, in particular with respect to the machine table, on the basis of the position of the first end face determined with respect to the machine tool, a position of the center of the core body on the first end face of the clamped optical waveguide with respect to the machine tool, in particular with respect to the machine table, on the basis of the position of the first end face of the clamped optical waveguide determined with respect to the machine tool and the relative position of the center of the core body on the first end face determined with respect to the shell body.

In an example, the optical measurement system is designed in such a way that when measuring the first end face, the light source device irradiates the second end face of the clamped optical waveguide.

In an example, the optical measurement system is designed in such a way that when measuring the first end face, the light source device irradiates the first end face of the clamped optical waveguide.

In an example, the optical measurement system further comprises a reflection device for reflecting the irradiating light provided by the light source device, which is arranged opposite and facing the second end face of the clamped optical waveguide when measuring the first end face.

In an example, with the optical measurement system in place, at least the detection device is arranged on a machine part that is movable relative to a machine frame of the machine tool, in particular on a machining device that is movable relative to the machine frame.

In an example, with the optical measurement system in place, at least the detection device is accommodated by the working spindle of the machining device.

Preferably, the light source device and detection device are designed as a uniform measuring device.

In an example, the control device is configured to control at least one of the plurality of numerically controllable axes for machining the clamped optical waveguide depending on one or more determination results of the evaluation unit of the control device.

The determination results are to be understood as any positions determined during the measurement of the first and/or second end face of the clamped optical waveguide.

In a preferred example, the machine tool for material-removing machining of the clamped optical waveguide comprises a tool held by the working spindle with a vibration generator which is configured to excite a part of the tool intended for material removal to vibrate during machining of the clamped optical waveguide, in particular with a vibration frequency in the ultrasonic range.

According to a fourth aspect, there is provided a control device for use on a machine tool according to the third aspect of the disclosure.

In this way, an existing machine tool can be relatively easily extended by the functionalities of the machine tool according to the third aspect of the disclosure, in particular by the possibilities for determining the position of the light wave guiding core body provided by the evaluation unit.

### BRIEF DESCRIPTION OF THE FIGURES

Further examples and their advantages as well as more specific examples of the aforementioned aspects and features are described below with the aid of the drawings shown in the accompanying figures:

FIGS. 1a and 1b show perspective views of schematic examples of optical waveguide before machining.

FIGS. 2a and 2b each show a schematic structure for carrying out the method according to a first and a second example of the first aspect of the disclosure.

FIG. 3 shows a perspective view of part of the structure in FIGS. 2a and 2b with machine table, clamping device and optical waveguide.

FIG. 4 shows a perspective view of a part of a machine tool according to an example of the third aspect of the disclosure.

FIG. 5a shows a flow chart of an exemplary sequence of a method according to an example of the first aspect of the disclosure.

FIG. 5b shows a flow chart, based on the flow chart of FIG. 5a, of an exemplary sequence of a method according to an example of the second aspect of the disclosure.

It is emphasized that the present disclosure is in no way limited to the examples described below and their respective features. The disclosure further includes modifications of said examples, in particular those resulting from modifications and/or combinations of individual or multiple features of the described examples within the scope of protection of the independent claims.

### DESCRIPTION

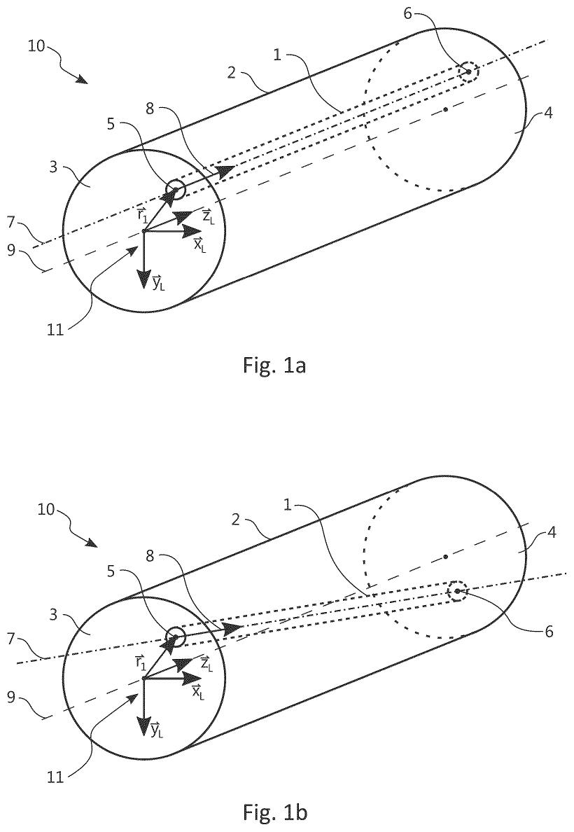

FIGS. 1a and 1b show perspective views of schematic examples of optical waveguide before machining.

FIG. 1a shows a cylindrically shaped optical waveguide 10 comprising a light wave guiding core body 1 and a shell body 2 enclosing it. Core body 1 and shell body 2 extend in relation to a longitudinal axis of the optical waveguide 10 from a first end face 3 to a second end face 4 of the optical waveguide 10. To describe the position of the core body 1 in relation to the shell body 2 as a reference system, an exemplary optical waveguide or shell body fixed coordinate system 11 is shown, the origin of which lies at the center of the first end face 3, whereby the base vectors \vec{x}_{L} and \vec{y}_{L} lie in the plane of the first end face 3 and the base vector \vec{z}z_{L} runs along a center line 9 of the optical waveguide 10.

The optical waveguides to be measured and subsequently machined usually have a substantially cylindrical shape, as shown here, with the core body 1 extending inside the shell body 2 also being substantially cylindrical. However, the disclosure is not intended to be limited to use on optical waveguides that are only shaped in this way.

Due to the manufacturing process, the core body 1 generally does not run exactly centrally in the shell body 2 along a center line 7 connecting a center point 5 on the first end face 3 and a center point 6 on the second end face 4. Thus, in the example shown in FIG. 1a, the core body 1 runs parallel to and at a distance from the center line 9 of the optical waveguide 10.

Center points are to be understood as surface center points of the respective cross-sectional surfaces on the first and second end faces 3, 4, wherein a cross-sectional surface of the optical waveguide corresponds precisely to the first or second end face 3, 4 itself.

To describe the position of the core body 1, a position vector can be used here \vec{r}₁ to the center point 5 on the first end face 3 or to the center point 6 on the second end face 4 and the direction vector 8 describing a direction of the center line 7 of the core body 1 can be used to describe the position of the core body 1.

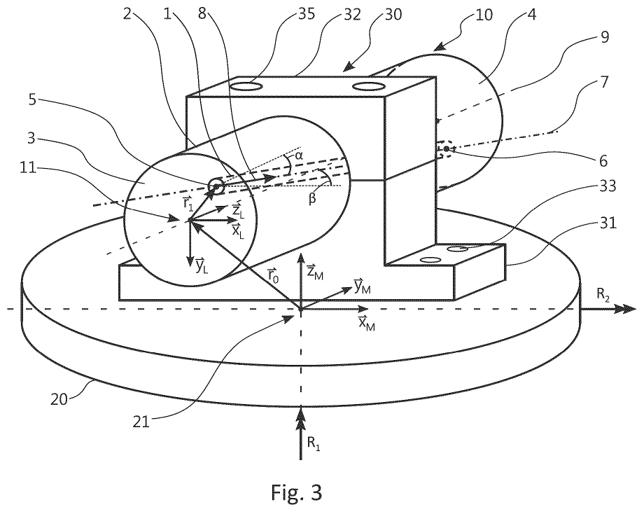

In contrast to the more specific case in FIG. 1a, FIG. 1b shows an exemplary optical waveguide 10 with a more general position of the core body 1 with respect to the shell body 2, in which the center line 7 of the core body 1 is not parallel to the center line 9 of the optical waveguide 10. Starting from the center point 5 on the first end face 3, the direction vector 8 of the center line 7 of the core body 1 is not orthogonal to the first end face 3, but has corresponding angles of inclination relative to a surface normal (which here runs parallel to \vec{z}_{L}) of the first end face 3 (see also FIG. 3).

As can be seen from the examples in FIGS. 1a and 1b, the position of the core body 1 with respect to the shell body 2 can vary greatly depending on the manufacturing process, so that a corresponding position determination is required in order to ensure accurate machining of the optical waveguide 10. This is advantageously solved by the method according to the first aspect of the disclosure, in the course of which at least the position of the center point 5 on the first end face 3 is determined. Particularly advantageously, the position of the center point 6 on the second end face 4 and the direction vector 8 of the center line 7 connecting the center points 5 and 6, which can be derived therefrom, are also determined.

Based on the above description of the optical waveguide, examples of the methods and the machine tool are explained below.

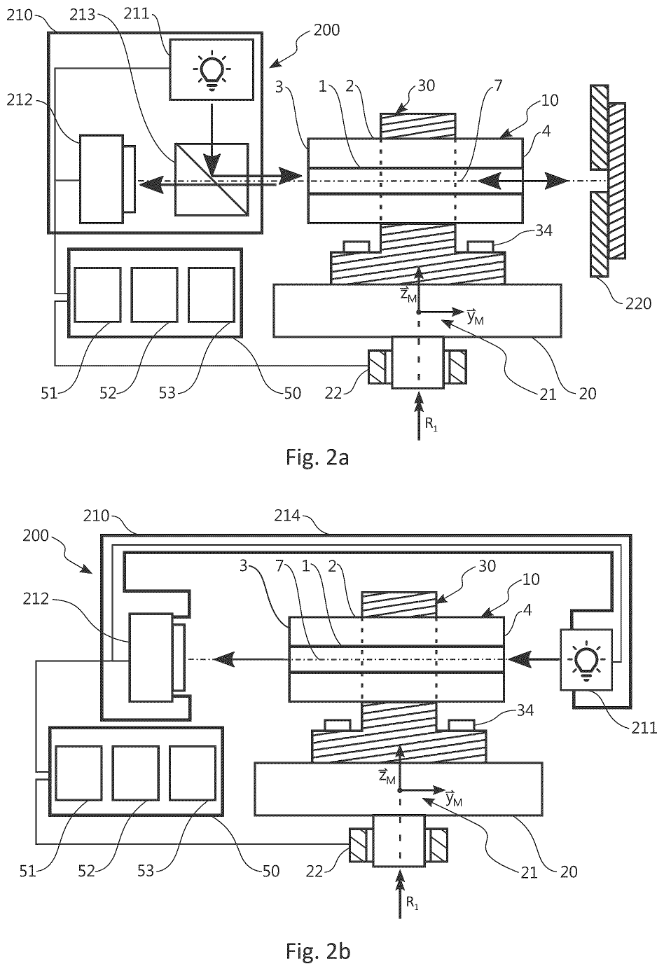

FIG. 2a shows a schematic structure for carrying out the method according to a first example of the first aspect of the disclosure for determining the position of the light wave guiding core body 1 of the clamped optical waveguide 10 when measuring the first end face 3 by irradiating the same on a partially depicted machine tool according to the third aspect.

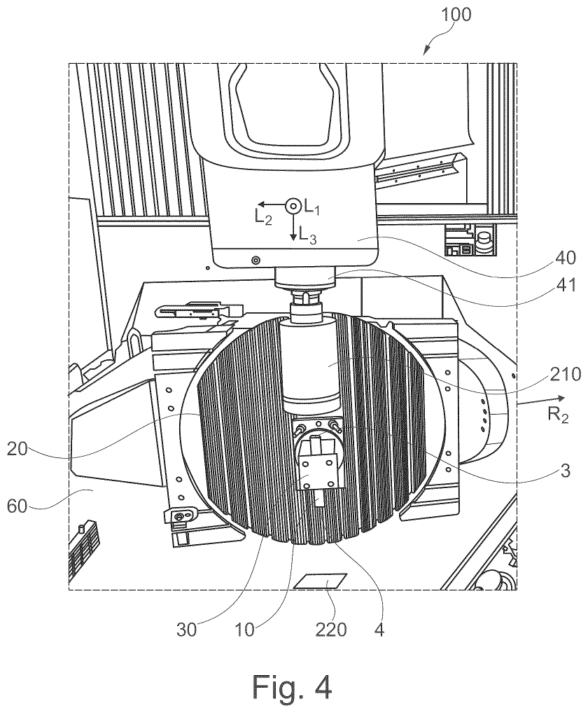

The optical waveguide 10 is clamped via a clamping device 30 on a machine table 20 of the machine tool not fully shown here, wherein the clamping device 30 is fastened to an upper side of the machine table 20 via corresponding fixing bolts 34. The machine table can be rotated about the first axis of rotation R₁ via a rotary axis with a drive 22, e.g. relative to a machine frame or a swivel arm of a rotary swivel table (see also FIG. 4).

The setup for determining the position comprises an optical measuring system 200, which comprises a light source 211 and a microscope camera 212, which are designed as a uniform measuring device 210 within the same housing, as well as a reflector 220. The beam path of the light source 211 and microscope camera 212 takes place through the same opening in the housing of the measuring device 210 and uses a semi-permeable mirror 213 for this purpose. The optical measurement system 200 is arranged on the machine tool, even if not explicitly shown here, and it should be noted that the structure shown is by no means limited to a microscope camera, but that any detection device that can detect at least part of the radiation emitted by the light source can be used.

When measuring the first end face 3, the measuring device 210 faces the first end face 3, whereby irradiating light from the light source 211 hits the first end face 3 via the semi-permeable mirror 213 and is partially transmitted and reflected there. The transmitted portion directed to the second end face 4 is largely reflected back onto the second end face 4 by the reflector facing the second end face 4 after emerging from the optical waveguide, such that an irradiating radiation emanating from the first end face in the direction of the measuring device 210 is essentially composed of reflected portions at the first end face 3 and portions of the irradiating radiation reflected at the reflector 220.

The irradiating light from the first end face 3 passes through the semi-permeable mirror 213 and is captured by the microscope camera 212 arranged behind it.

The optical measurement system 200 is coupled to a control device 50 of the machine tool, which comprises at least one evaluation unit 51. Preferably, the control device 50 further comprises a control unit 52 for controlling the numerically controllable axes of the machine tool and a storage unit 53 in which received data as well as control programs for the machine tool can be stored for retrieval.

The radiation captured by the microscope camera 212 is either converted by the microscope camera 212 into corresponding image data and transmitted to the evaluation unit 51 of the control device 50, or the captured raw data (capture data) is transmitted directly.

The evaluation unit 51 is configured to determine a position of a center point of the core body 1 of the clamped optical waveguide 10 on the first end face 3 on the basis of the transmitted data. For this purpose, any common prior art image and pattern recognition methods can be used which, based on the differences in the radiation components of the core body 1 and shell body 2, recognize them as different objects in the evaluated acquisition data and determine the center of the core body 1 and its position relative to the shell body 2 on the first end face 3 using any mathematical methods, usually numerical methods.

The position determined by the evaluation unit 51 is output in a form that can be used by the control device 50, so that subsequent machining of the clamped optical waveguide 10 can take place depending on said determined position.

Preferably, the position of the center point of the core body 1 determined with respect to the shell body 2 is offset directly against a position of the optical waveguide 10 with respect to the machine tool, e.g. with respect to the machine table 20, in order to obtain a position of the center point with respect to the machine tool. The position of the optical waveguide can, for example, be indicated by a position vector of an optical waveguide point in the machine-table-fixed coordinate system 21 (see also FIG. 3).

After the first end face 3 of the optical waveguide 10 has been measured, it can be rotated by 180° by rotating the machine table 20 about the first axis of rotation R₁, so that the second end face 4 can be measured in a similar manner. In this sense, the position determination is preferably carried out completely automatically by the control device 50, which, after receiving the image or acquisition data for the first end face 3, independently instructs a realignment for measuring the second end face 4 and further controls the light source 211 and microscope camera 212 in the process (as also when measuring the first end face 3).

FIG. 2b shows a schematic structure for carrying out the method according to a second example of the first aspect of the disclosure for determining the position of the light wave guiding core body 1 of the clamped optical waveguide 10 when measuring the first end face 3 with irradiating the second end face 4 on a partially depicted machine tool according to the third aspect.

The structure shown in FIG. 2b corresponds largely to that in FIG. 2a, although the optical measurement system 200 and correspondingly the procedure for determining the position differ.

In FIG. 2b, the light source 211 and the detection device are also designed as a uniform measuring device 210, but in contrast to the structure in FIG. 2a, the second end face 4 of the mounted optical waveguide 10 is irradiated. For this purpose, the measuring device 210 has an exemplary U-shaped design with a web 214 spanning the optical waveguide 10, which allows the optical waveguide 10 to be arranged between the microscope camera 212 and the light source 211.

In this case, the radiation emitted by the first end face 3 and detected by the detection device 212 essentially consists of components of the irradiating second end face 4 transmitted by the light source 211 through the optical waveguide 10. The evaluation by the evaluation unit 51 based on this is identical to the process in FIG. 2a.

FIG. 3 shows a perspective view of part of the structure of FIGS. 2a and 2b with machine table 20, clamping device 30 and mounted optical waveguide 10, the simplified representation of the optical waveguide 10 having been replaced by a representation as shown in FIG. 1b.

In addition to the illustrations in FIGS. 2a and 2b, FIG. 3 shows a detailed structure of the clamping device 30, which comprises a lower part 31 and an upper part 32, between which the optical waveguide 10 is clamped. The clamping is carried out by means of corresponding clamping bolts (not shown here), which are inserted into the upper part 32 through the holes 35 on the upper side and screwed into the lower part 31 with a suitable threaded counterpart in order to fix the optical waveguide 10 located between the lower and upper parts 31, 32.

The clamping device 30 itself is fixed to an upper side of the machine table 20 via the fixing bolts (see FIGS. 2a, 2b), which are guided through the holes 33, whereby the optical waveguide device 10 is clamped on the machine table 20.

In addition to FIGS. 2a and 2b, the machine table 20 also has a second rotary axis with which it can be rotated about a second axis of rotation R₂, which in FIG. 3 runs orthogonally to the first axis of rotation R₁.

The following is an exemplary description of a position of the center line 7 of the core body 1 of the clamped optical waveguide 10 with respect to the machine tool or the machine table 20 of the machine tool as a correspondingly selected reference system of the machine tool.

An orthonormal and machine-table-fixed coordinate system 21 was selected for the description of the machine table 20. The origin of the coordinate system 21 was placed in the center of the machine table 20 as an example, whereby base vectors \vec{x}_{M} and \vec{y}_{M} run parallel to the top of the machine table 20 and base vector \vec{z}_{M} is orthogonal to it.

By measuring the first end face 3 and the second end face 4 in the sense of an example of the method according to the first aspect of the disclosure, both the center point 5 on the first end face 3 and the center point 6 on the second end face 4 can be indicated with respect to the shell body 2 or the optical waveguide 10 itself. By way of example, only the position vector running in the optical waveguide fixed coordinate system 11 is shown. \vec{r}₁ is shown. By vector addition with an equivalent not shown here for the center point 6 on the second end face 4, the direction vector 8 of the center line 7 is determined, which can be described, for example, via the inclination angles α and β shown in relation to the first end face 3.

The position of the optical waveguide 10 is described by the position vector \vec{r}₀ from the origin of the machine-table-fixed coordinate system 22 to the origin of the optical waveguide-fixed coordinate system 11. \vec{r}₁ can be used to specify the center point 5 with respect to the machine table 20. The position vector \vec{r}₀ can be determined, for example, with the aid of a tactile measurement system of the machine tool, with which at least the first end face is probed for the purpose of determining the position. The orientation of the center line 7 in relation to the machine table can be described analogously using the direction vector 8.

The base vectors of the coordinate systems 11 and 21 shown in FIG. 3 run parallel in pairs, so that a description of the orientation of the first end face 3 in relation to the machine table 20, e.g. by inclination angles, is not necessary or trivial. At this point, it should be noted that the first end face may well be inclined relative to the coordinate system 21 of the machine table 20 due to clamping or also due to production and that corresponding angles of inclination must be determined to indicate a position of the first end face 3 relative to the machine table 20. For this purpose, for example, several surface points of the optical waveguide or the first end face 3 can be probed with the tactile measurement system, whereby the plane of the first end face 3 can be described, among other things, in the machine-table-fixed coordinate system 22.

FIG. 4 shows a perspective view of a part of a machine tool 100 according to an example of the third aspect of the disclosure, with a structure substantially corresponding to that in FIG. 1a for measuring a first end face 3 of a clamped optical waveguide 10.

The machine tool 100 is designed as a 5-axis machine and comprises a machine frame 60, a machining device 40 which is movable relative to this via three linear axes along the directions L₁, L₂ and L₃ (forwards and backwards in each case) and which carries a working spindle 41, and a machine table 20 which is designed as a rotary swivel table relative to the machine frame 60 about two rotary axes and on the upper side of which a clamping device 30 with an optical waveguide 10 clamped in it is fastened. The axis of rotation of the first rotary axis, which is not shown here, runs orthogonally to the table surface on which the clamping device 3 is fastened and the axis of rotation R₂ of the second rotary axis again runs orthogonally to the axis of rotation of the first rotary axis.

In the configuration shown, a unitary measuring device 210 is accommodated in the working spindle 41, the measuring device essentially corresponding to the measuring device shown in FIG. 1a and having a microscope camera and a light source arranged inside it.

Measuring device 210 and optical waveguide 10 can be positioned relative to one another by means of traversing movements, the orientation shown having been adopted for the purpose of measuring the first end face 3 of the clamped optical waveguide 10 according to a method according to the first aspect of the disclosure, in the course of which the optical waveguide 10, which is vertically aligned by means of rotational movements of the machine table 20, is irradiated at its first end face 3.

A reflector 220 is arranged below the machine table 20, which reflects the transmitted irradiating light back onto the second end face 4 of the optical waveguide 10, so that it is detected as radiation by the microscope camera of the measuring device 210, which is directed onto the first end face 3, in order to increase the contrast.

The machine tool 100 comprises a control device, not shown here, which is coupled to the measuring device 210 received in the working spindle 41 and comprises an evaluation unit for evaluating the radiation detected by the microscope camera to determine a relative position of a center point of the core body on the first end face 3 with respect to the shell body.

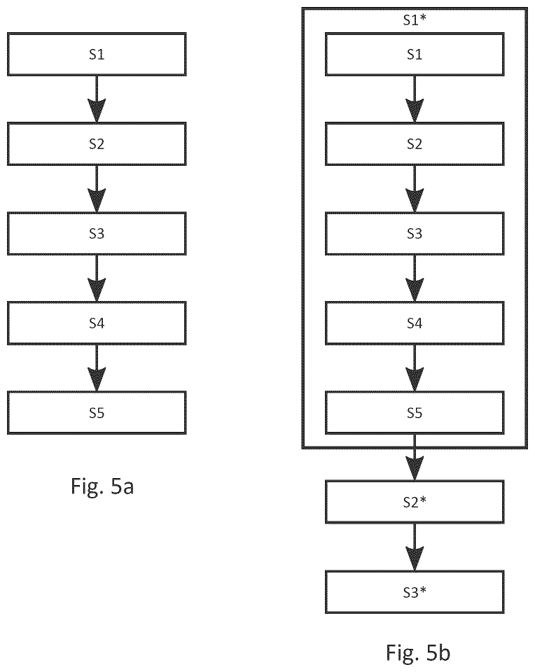

FIG. 5a shows a flow chart of an exemplary sequence of a method according to an example of the first aspect of the disclosure.

In step S1, an optical waveguide is clamped on a machine table of a numerically controlled machine tool, on which an optical measurement system comprising at least a light source device and a detection device is arranged. The optical waveguide has at least one light wave guiding core body and a shell body enclosing it, which extend from a first end face of the optical waveguide to a second end face of the optical waveguide.

In steps S2 to S5, the first end face of the clamped optical waveguide is measured by means of the optical measuring system arranged on the machine tool.

In step S2, the clamped optical waveguide is aligned with respect to the optical measurement system.

In step S3, the clamped optical waveguide is irradiated by means of the light source device of the optical measurement system, in particular the first or the second end face of the clamped optical waveguide.

In step S4, the detection device of the optical measuring system detects the radiation emitted by the first end face of the optical waveguide caused by irradiating the optical waveguide.

In step S5, a position of a center point of the core body relative to the shell body on the first end face of the spanned optical waveguide is determined on the basis of the radiation detected in step S4.

FIG. 5b shows a flow chart of an exemplary sequence of a method according to an example of the second aspect of the disclosure.

In a first step S1*, the position of a light wave guiding core body of an optical waveguide to be machined in the course of the method is determined on a numerically controlled machine tool with a machine table and a machining device with a working spindle configured to receive a tool, the machine tool being configured to move the machine table and the machining device relative to one another via a plurality of numerically controllable axes. The position is determined according to a method according to the first aspect of the disclosure and corresponds in FIG. 5b precisely to the sequence described in FIG. 5a with the analogous steps S1 to S5.

In step S2*, a position determined in the course of step S1* is made available to a control device of the numerically controlled machine tool set up for controlling the machine tool.

In step S3*, machining of the optical waveguide clamped in step S1 from step S1* (as before) is ultimately carried out by means of a tool received by the working spindle of the machine tool, at least as a function of the position determined from step S2* and made available to the control device.

Above, examples of the present disclosure and the advantages thereof have been described in detail with reference to the accompanying figures.

It is again emphasized that the present disclosure is in no way limited to the above-described examples and their respective features. The disclosure further includes modifications of said examples, in particular those resulting from modifications and/or combinations of individual or multiple features of the described examples within the scope of protection of the independent claims.

### LIST OF REFERENCE SYMBOLS

1 core body
2 shell body
3 first end face
4 second end face
5 center of the core body on the first end face
6 center of the core body on the first end face
7 centerline of the core body
8 direction vector of the center line
9 centerline of the optical waveguide
10 optical waveguide
11 optical waveguide fixed coordinate system
20 machine table
21 machine-table-fixed coordinate system
22 drive for first rotary axis
30 clamping device
31 lower part of the clamping device
32 upper part of the clamping device
33 holes for fixing bolts
34 fixing bolt
35 holes for clamping bolts
40 machining device
41 working spindle
50 control device
51 evaluation unit
52 control unit for controllable axes
53 storage unit
60 machine frame
100 machine tool
200 optical measurement system
210 measuring device
211 light source
212 microscope camera
213 semi-permeable mirror
214 bar
220 reflector
R₁ first axis of rotation
R₂ second axis of rotation
L₁ first translational direction
L₂ second translational direction
L₃ third translational direction

What is claimed is:

1. Method for determining a position of a light wave guiding core body of an optical waveguide for machining on a numerically controlled machine tool,
wherein the optical waveguide comprises the core body and a shell body enclosing the core body, the core body and the shell body extending from a first end face of the optical waveguide to a second end face of the optical waveguide,
comprising:
providing an optical measurement system comprising at least a light source device and a detection device;
measuring the first end face of the optical waveguide by the optical measurement system, comprising:
irradiating the optical waveguide by the light source device;
detecting, by the detection device, radiation emitted from the first end face as a result of irradiating the optical waveguide; and
determining a position, relative to the shell body, of a center point of the core body on the first end face based on the detected radiation;
further comprising:
clamping the optical waveguide on a machine table of the numerically controlled machine tool;
wherein the optical measurement system is arranged on the numerically controlled machine tool and the measurement of the first end face on the optical waveguide clamped on the machine table is carried out by the optical measurement system arranged on the numerically controlled machine tool.

2. Method according to claim 1, wherein:
for measuring the first end face of the clamped optical waveguide, irradiating the optical waveguide comprises:
irradiating at least a subsection of the second end face of the clamped optical waveguide by the light source device.

3. Method according to claim 1, wherein:
for measuring the first end face of the clamped optical waveguide, irradiating the optical waveguide comprises:
irradiating at least a subsection of the first end face of the clamped optical waveguide by the light source device.

4. Method according to claim 2, wherein:
the optical measurement system further comprises a reflection device for reflecting the irradiating light provided by the light source device,
and measuring the first end face of the clamped optical waveguide further comprises:
arrangement of the reflection device opposite the second end face of the clamped optical waveguide and facing it, in such a way that the reflection device reflects at least a portion of the radiation guided through the optical waveguide starting from the irradiated first end face and subsequently emanating from the second end face back onto the second end face.

5. Method according to claim 1, wherein:
the detection device and the light source device of the optical measurement system are designed as a uniform measuring device.

6. Method according to claim 1, wherein:
at least a part of the optical measurement system, optionally, the detection device, and the machine table are movable relative to one another by at least one numerically controllable axis of the numerically controlled machine tool.

7. Method according to claim 6, wherein:
the numerically controlled machine tool comprises a machining device with a working spindle configured to receive a tool, at least the detection device of the optical measurement system being arranged on the machining device, and
the numerically controlled machine tool is configured to move the machine table and the machining device relative to one another via a plurality of numerically controllable axes, optionally three linear axes and two rotary axes.

8. Method according to claim 7, wherein:
at least the detection device of the optical measurement system is received by the working spindle of the machining device.

9. Method according to claim 1,
further comprising:
determining a position of the first end face of the clamped optical waveguide with respect to the numerically controlled machine tool in a first coordinate system of the numerically controlled machine tool, optionally with respect to the machine table in a machine-table-fixed coordinate system; and
determining a position of the center point of the core body on the first end face of the clamped optical waveguide with respect to the numerically controlled machine tool in the first coordinate system of the numerically controlled machine tool, optionally with respect to the machine table in the machine-table-fixed coordinate system, based on the determined position of the first end face of the clamped optical waveguide and the determined relative position of the center point of the core body on the first end face with respect to the shell body.

10. Method according to claim 9, wherein:
the determination of the position of the first end face of the clamped optical waveguide with respect to the numerically controlled machine tool is carried out using a tactile measurement system arranged on the numerically controlled machine tool with a touch probe device.

11. Method according to claim 9,
further comprising:
determining a position of a center line of the core body with respect to the numerically controlled machine tool based on the position, determined with respect to the numerically controlled machine tool, of the center point of the core body on the first end face of the clamped optical waveguide and the position, determined with respect to the numerically controlled machine tool, of the first end face of the clamped optical waveguide.

12. Method according to claim 9,
further comprising:
measuring the second end face of the clamped optical waveguide by the optical measurement system arranged on the numerically controlled machine tool, comprising:
irradiating the clamped optical waveguide by the light source device;
detecting, by the detection device, a radiation emitted from the second end face due to the irradiating of the clamped optical waveguide; and
determining a position, relative to the shell body, of a center point of the core body on the second end face based on the detected radiation emanating from the second end face;
determining a position of the second end face of the clamped optical waveguide with respect to the numerically controlled machine tool in the first or in a further coordinate system of the numerically controlled machine tool, optionally with respect to the machine table in the machine-table-fixed coordinate system; and
determining a position of the center point of the core body on the second end face of the clamped optical waveguide with respect to the numerically controlled machine tool in the first or in the further coordinate system of the numerically controlled machine tool, optionally with respect to the machine table in the machine-table-fixed coordinate system, based on the position of the second end face of the clamped optical waveguide determined with respect to the numerically controlled machine tool and the determined relative position of the center point of the core body on the second end face with respect to the shell body.

13. Method according to claim 12,
further comprising:
determining a position of a center line of the core body with respect to the numerically controlled machine tool based on the positions of the center points of the core body on the first and second end faces of the clamped optical waveguide determined with respect to the numerically controlled machine tool.

14. Method for machining an optical waveguide on a numerically controlled machine tool,
wherein the optical waveguide has at least one light wave guiding core body and a shell body enclosing it, which both extend from a first end face of the optical waveguide to a second end face of the optical waveguide,
comprising:
providing a numerically controlled machine tool with a machine table and a machining device with a working spindle arranged to receive the tool, wherein the numerically controlled machine tool is arranged to move the machine table and the machining device relative to one another via a plurality of numerically controllable axes, optionally via three linear axes and two rotary axes;
clamping the optical waveguide onto the machine table of the numerically controlled machine tool;
determining a position of the light wave guiding core body of the optical waveguide mounted on the machine table according to a method according to claim 1;
providing the determined position to a control device configured to control the numerically controlled machine tool;
machining of the clamped optical waveguide by the tool received by the working spindle, at least as a function of the position determined and provided to the control device.

15. Method according to claim 14, further comprising:
for determining the position of the light wave guiding core body:
receiving the detection device and optionally the light source device of the optical measurement system by the working spindle of the numerically controlled machine tool;
and for machining the clamped optical waveguide
picking up the tool by the working spindle of the numerically controlled machine tool;
takes place.

16. Method according to claim 14, wherein:
the machining of the clamped optical waveguide is a material removing machining.

17. Method according to claim 16, wherein:
the tool received by the working spindle for machining the optical waveguide comprises a vibration generator which is configured to excite a part of the tool intended for material removing to vibrate during machining of the clamped optical waveguide, optionally with a vibration frequency in an ultrasonic range.

18. Method according to claim 16, wherein:
for providing a position of a center line of the core body of the clamped optical waveguide to the control device, the determination of the position of the light wave guiding core body of the clamped optical waveguide further comprises,
determining a position of the first end face of the clamped optical waveguide with respect to the numerically controlled machine tool in a first coordinate system of the numerically controlled machine tool, optionally with respect to the machine table in a machine-table-fixed coordinate system;
determining a position of the center point of the core body on the first end face of the clamped optical waveguide with respect to the numerically controlled machine tool in the first coordinate system of the numerically controlled machine tool, in particular with respect to the machine table in the machine-table-fixed coordinate system, based on the determined position of the first end face of the clamped optical waveguide and the determined relative position of the center point of the core body on the first end face with respect to the shell body; and
determining a position of a center line of the core body with respect to the numerically controlled machine tool based on the position, determined with respect to the numerically controlled machine tool, of the center point of the core body on the first end face of the clamped optical waveguide and the position, determined with respect to the numerically controlled machine tool, of the first end face of the clamped optical waveguide;
and machining of the clamped optical waveguide comprises:
inserting at least one channel into the shell body of the clamped optical waveguide, wherein the channel to be inserted extends from the first end face substantially parallel to the center line of the core body at least partially through the shell body, optionally continuously as far as the second end face.

19. Method according to claim 18, wherein:
the inserting of the at least one channel into the shell body comprises:
aligning the machine table and the machining device by driving one or more axes of the plurality of numerically controllable axes in response to the position of the center line of the core body provided to the control device, such that the center line of the core body is substantially parallel to an extension of a spindle axis of a tool-carrying working spindle; and
relatively moving the tool-carrying working spindle and the machine table in a feed direction along the spindle axis.

20. Machine tool for machining an optical waveguide,
which has at least one light wave guiding core body and a shell body enclosing it, which both extend from a first end face of the optical waveguide to a second end face of the optical waveguide,
wherein the machine tool is a numerically controlled machine tool and comprises:
a machine table;
a machining device with a working spindle arranged to receive a tool;
a control device arranged to control the machine tool; and
a plurality of numerically controllable axes, controllable via the control device for relative movement of the machine table and the machining device;
wherein:
an optical measurement system can be arranged on the machine tool, the optical measurement system comprising a light source device and a detection device and can be coupled to the control device;
and the control device, with the optical measurement system arranged on the machine tool, is configured to measure, by means of the optical measurement system, the first end face of the optical waveguide clamped on the machine table,
wherein the control device is configured to control the light source device in such a way that it irradiates the clamped optical waveguide,
the detection device is configured to detect a radiation emanating from the first end face of the irradiated clamped optical waveguide and to transmit this descriptive detection data to an evaluation unit of the control device,
and the evaluation unit is configured to determine, based on the transmitted descriptive detection data, a position, relative to the shell body, of a center point of the core body on the first end face of the clamped optical waveguide.

21. The machine tool according to claim 20, wherein:
the evaluation unit of the control device is configured to determine a position of the first end face of the clamped optical waveguide with respect to the machine tool, in particular with respect to the machine table, in particular by means of a tactile measuring system, and is further configured to determine a position of the center point of the core body on the first end face of the clamped optical waveguide with respect to the machine tool, in particular with respect to the machine table, based on the position of the first end face of the clamped optical waveguide determined with respect to the machine tool and the relative position of the center point of the core body on the first end face determined with respect to the shell body.

22. The machine tool according to claim 20, wherein:
the optical measurement system is designed in such a way that when measuring the first end face, the light source device irradiates the second end face of the clamped optical waveguide.

23. The machine tool according to claim 22, wherein:
the optical measurement system is designed in such a way that when measuring the first end face, the light source device irradiates the first end face of the clamped optical waveguide.

24. The machine tool according to claim 23, wherein:
the optical measurement system further comprises a reflection device for reflecting irradiating light provided by the light source device, which is arranged opposite the second end face of the clamped optical waveguide when measuring the first end face and faces the first end.

25. The machine tool according to claim 20, wherein:
with the optical measurement system arranged, at least the detection device is arranged on a machine part which is movable relative to a machine frame of the machine tool, on the machining device which is movable relative to the machine frame.

26. The machine tool according to claim 25, wherein:
with the optical measurement system arranged, at least the detection device is received by the working spindle of the machining device.

27. The machine tool according to claim 20, wherein:
the control device is configured to control at least one of the plurality of numerically controllable axes as a function of one or more determination results of the evaluation unit of the control device for machining the clamped optical waveguide.

28. The machine tool according to claim 20, wherein:
the machine tool for material removing machining of the clamped optical waveguide comprises a tool which is received by the working spindle and has a vibration generator which is configured to excite a part of the tool provided for material removing to vibrate during machining of the clamped optical waveguide, optionally with a vibration frequency in an ultrasonic range.

29. A control device for use on the machine tool according to claim 20.
